(19) United States
(12) Patent Application Publication
(10) Pub. No.: US 2003/0158290 A1
(43) Pub. Date: Aug. 21, 2003

(54) Method for producing foundry shapes

(76) Inventors: Victor S. LaFay, Cincinnati, OH (US); Stephen L. Neltner, Alexandria, KY (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/293,746

(22) Filed: Nov. 13, 2002

Related U.S. Application Data
(60) Provisional application No. 60/414,809, filed on Sep. 30, 2002.
(60) Provisional application No. 60/332,679, filed on Nov. 14, 2001.

(51) Int. Cl. C08K 3/34; B22C 1/00; B22C 3/00

(52) U.S. Cl. 523/139; 524/492; 524/447; 523/143

(57) ABSTRACT

A method for producing silica sand-based foundry shapes useful in forming metal castings and for reducing veining defects in sand-based foundry shapes by providing a foundry sand, adding an anti-veining composition that comprises bentonite to the foundry sand to form a mineral composition, then adding a foundry resin to the mineral composition to form a sand-based foundry composition and shaping the sand-based foundry composition to form a desired pattern.

### CROSS REFERENCE TO RELATED APPLICATIONS

This application claims priority from U.S. Provisional Application Ser. No. 60/414,809, filed Sep. 30, 2002 and U.S. Provisional Application Ser. No. 60/332,679, filed Nov. 14, 2001.

### BACKGROUND OF THE INVENTION

The present invention relates to a method for producing foundry shapes and, more specifically, to a method of reducing veining defects in sand-based foundry shapes by adding an anti-veining compound comprising bentonite.

Sand casting is a process used in the foundry industry to produce metal parts. In sand casting, disposable foundry shapes, such as cores and molds, are made by forming a sand-based foundry composition into the desired shape and curing the composition. One or more binders mixed with the silica sand are required to maintain the sand in a predetermined shape. Commonly employed binders include inorganic binders such as clay and foundry resins such as phenolic resin binders. There are two basic types of binder systems used in the foundry industry. Green sands are produced by binding silica sand with clay, coal dust, and water. Chemically bonded sands use a variety of organic and inorganic resin binders.

Green sand molding is the production of molded metal objects from tempered molding sand and is widely used to cast ferrous as well as non-ferrous metal castings. Green sand molding is economical and permits both quality and quantity production, particularly for smaller castings. Green sand is defined as a water tempered molding sand mixture with plasticity. A green sand mold used for casting steel usually consists of silica sand, and a binding agent mulled together with tempered water. Other useful foundry sands include chromite, zircon and olivine sands.

Chemically bonded sands refer to sand-based foundry compositions comprising sand and a binding amount of a polymerizable or curable binder. The binder permits the foundry composition to be molded or shaped into the desired form and thereafter cured to form a self-supporting structure. The polymerizable or curable binder is caused to polymerize by the addition of catalyst and/or heat to convert the formed, uncured foundry sand composition into a hard, solid, cured state. Examples of curable resin compositions useful as binders in the foundry art include phenolic and furan resins. In a typical no-bake process, the sand, binder, and a liquid curing catalyst are mixed and compacted to produce a cured mold and/or core. A binder commonly used in the no-bake process is a polyurethane binder derived by curing a polyurethane-forming binder with a liquid tertiary amine catalyst.

Silica sand grains expand upon heating. When the grains are too close, the molding sand moves and expands causing a variety of defects in the castings. One such defect is veining which refers to a discontinuity on the surface of the casting appearing as a raised, narrow ridge that forms upon cracking of the sand mold or core due to expansion of the sand during the filling of the mold with the molten metal.

Iron oxides have been used for years in foundry applications to improve core properties and the quality of castings. Iron oxides have proven to be advantageous as an additive to foundry molding aggregates containing silica sand to improve the quality of castings by reducing the formation of thermal expansion defects, such as veining, scabs, buckles, and rat tails as well as gas defects, such as pinholes and metal penetration. There are several iron oxides which are currently used in foundries today. These include red iron oxide, also known as hematite (Fe₂O₃), black iron oxide, also known as magnetite (Fe₃O₄) and yellow ochre. Another iron oxide which is presently being used is Sierra Leone concentrate which is a hematite ore black in color. Red iron oxide and black iron oxide are the most popular iron oxides in use.

One method of employing the above iron oxides is to add approximately 1-3% by weight to the sand mold aggregates during mixing. The exact mechanism by which iron oxides affect surface finish is not totally understood. However, it is generally believed that the iron oxides increase the hot plasticity of the sand mixture by the formation of a glassy layer between the sand grains which deforms and “gives,” without fracturing at metallurgical temperatures, to prevent fissures from opening up in the sand, which in turn reduces veining.

Various other types of additives have also been employed in an attempt to improve core properties and the quality of sand castings. For example, other anti-veining compounds which have been utilized in sand aggregate mixtures include starch based products, dextrin, fine ground glass particles, red talc and wood flour, i.e. particles of wood coated with a resin. All of these additives have met with limited success in reducing veining.

U.S. Pat. No. 5,911,269 to Brander et al. discloses the use of lithia-containing materials in silica sand molds and cores to reduce thermal expansion defects, such as veining. The addition of lithia-containing additives to the foundry sand composition can add significantly to the expense of the overall foundry operation.

Although it is known to use bentonite clays as binders for foundry green sand molds or cores, bentonite clays have not been used as anti-veining additives in chemically bonded sand compositions. Quite surprisingly, it has been found that when bentonite clay is used as an anti-veining additive in conjunction with a chemically bonded-based foundry sand, the quality of the castings improves by reducing veining defects.

U.S. Pat. No. 4,216,133 to Johnson et al. discloses a shell process foundry resin composition containing novolak resins incorporating from about 0.5% to about 10% based on weight of the resin of a finely divided, siliceous material, such as bentonite. According to Johnson et al., the finely divided siliceous material incorporated in the foundry resin composition provides peel back resistance and increased stripping strength. Furthermore, Johnson et al. emphasized that the siliceous material is added to the resin material and is not merely added to the sand mixture in the muller. The incorporation of the siliceous material is thought to control viscosity during cure. The amount of siliceous material in the composition based on sand is only 0.05% to 0.8%. It should be noted that there is no indication or suggestion of using bentonite as an anti-veining composition in the '133 patent. Veining is not typically considered a problem in a shell molding process.

### SUMMARY OF THE INVENTION

The present invention relates to a method for producing chemically bonded foundry shapes by incorporating an anti-veining composition comprising bentonite into a silica sand aggregate. The anti-veining composition is mixed with foundry sand used in the production of foundry cores and molds to improve the quality of castings by reducing thermal expansion defects, such as veining, in iron, steel and non-ferrous castings.

In accordance with one embodiment of the present invention, a method of producing a silica sand-based foundry shape is disclosed. The process comprises the steps of providing a foundry sand, adding an anti-veining composition to the sand to form a mineral composition, adding a foundry resin to the mineral composition to form a sand-based foundry composition, and shaping the sand-based foundry composition into a desired pattern, wherein the anti-veining composition comprises bentonite.

The sand-based foundry composition used to produce cores and molds in accordance with the present invention typically comprises about 95% to about 99.5% of a sand based mineral composition and about 5% to about 0.5% of a foundry resin appropriate for sand cores and molds. The sand based mineral composition contains about 1% to about 10% of an anti-veining additive. Thus, the amount of anti-veining additive is based on the total amount of the mineral composition, i.e., the total amount of sand and anti-veining additive. The amount of resin is based on the total composition weight.

The anti-veining additive comprises bentonite. The type of bentonite is not particularly limited and can be a water-soluble sodium bentonite clay or a low-soluble calcium bentonite clay. The anti-veining addititve may also include other clay minerals such as hectorite, illite, mixtures of illite and the family of smectites, shale, and other families of clay materials. In accordance with particular aspects of the present invention, the bentonite clay may have an average particle size of from about 74μ to about 3.5 mm.

The addition of bentonite to foundry molding and core compositions significantly reduces the casting defects associated with the thermal expansion of silica and dramatically improves the surface finish of such castings. One of the major causes of veining occurs when silica sand is rapidly heated causing the silica to undergo a rapid expansion and form fissures that the hot metal penetrates. The addition of bentonite improves the resulting casting quality. Although not wishing to be bound, applicants believe that the reduction in veining defects relates to the crystalline structure of bentonite which can decompose and collapse thereby providing room for the expansion of the silica sand during heating. In addition, it is believed that the loss of crystalline water from the mineral reduces gas defects.

The incorporation of bentonite into the silica sand foundry composition substantially improves the surface appearance of the casting and can eliminate or reduce the need for extensive surface grinding to remove any projecting veins from the casting. Accordingly, eliminating veining can significantly reduce the cost of the casting. Furthermore, bentonite is considerably less expensive than other anti-veining additives like lithia containing materials, thereby further reducing the cost of the casting.

### BRIEF DESCRIPTION OF THE DRAWINGS

FIG. 1 is a view of a control test casting without vein reduction additives illustrating a plurality of veining defects;

FIG. 2 is a view of a test casting incorporating bentonite in the silica sand foundry composition using 5% by weight of the mineral composition of blend 1 which comprises bentonite in accordance with the present invention;

FIG. 3 is a view of a test casting incorporating bentonite in the silica sand foundry composition using 5% by weight of the mineral composition of blend 2 which comprises a 50/50 mixture of bentonite and coal slag in accordance with the present invention;

FIG. 4(a) is an illustration of the erosion wedge casting with the best rating 1;

FIG. 4(b) is an illustration of the erosion wedge casting with the worst rating 5;

FIG. 5(a) is an illustration of the stepcone casting vein with the best rating 1;

FIG. 5(b) is an illustration of the stepcone casting vein with the poor rating 4;

FIG. 6(a) is an illustration of the penetration casting vein with the best rating 1;

FIG. 6(b) is an illustration of the penetration casting vein with the worst rating 5;

FIG. 7(a) is an illustration of the penetration casting penetration with the best rating 1;

FIG. 7(b) is an illustration of the penetration casting penetration with the worst rating 5;

FIG. 8(a) is an illustration of the fluidity spiral—flow in inches (41 in); and

FIG. 8(b) is an illustration of the fluidity spiral—flow in inches (52 in).

### DETAILED DESCRIPTION OF THE INVENTION

The present invention relates to a method of making a silica sand-based foundry shape wherein an anti-veining composition comprising bentonite is incorporated in the silica sand-based based composition to reduce veining. The anti-veining additive produces a sand-based foundry mold and core composition which resists the formation of some of the defects commonly associated with the production of castings produced by silica, sand-based foundry mold and core compositions. In particular, the anti-veining additive improves the quality of the castings by reducing thermal expansion defects, such as veining, in iron, steel and non-ferrous castings.

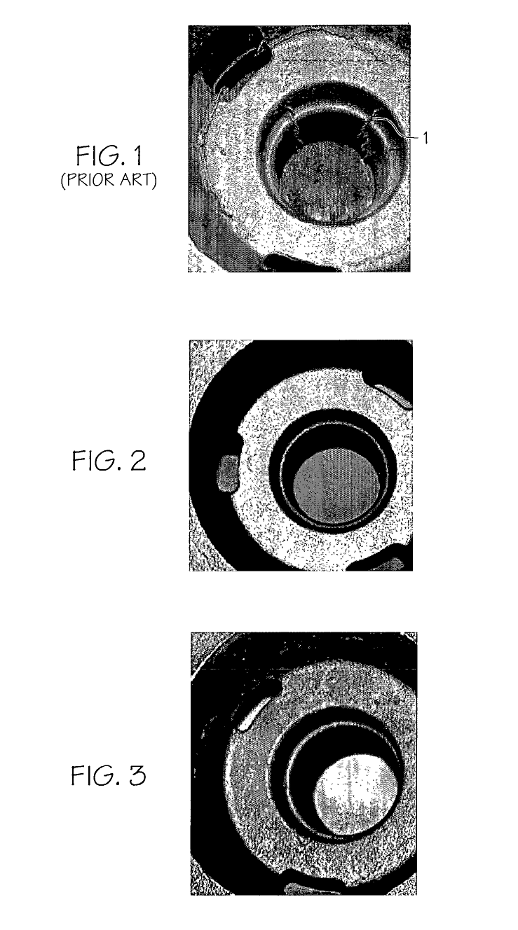

FIG. 1 is a view of a control test casting without vein reduction additives illustrating a plurality of veining defects 1. FIG. 2 is a view of test casting incorporating bentonite in the silica sand foundry composition using 5% by weight of the mineral composition of blend 1 which includes bentonite in accordance with the present invention. FIG. 3 is a view of test casting incorporating bentonite in the silica sand foundry composition using 5% by weight of the mineral composition of blend 2 which includes a 50/50 mixture of bentonite and coal slag in accordance with the present invention.

The anti-veining additive of the present invention may be utilized with conventional foundry silica sand molding and core compositions used in the manufacture of sand-based shapes. Such foundry compositions are typically made from silica sand, with the sand grains being bound together with a mechanical or chemical means. An example of a commercially available foundry sand is Wedron 520 available from Fairmount Minerals. Typically, the mold or core mixture may comprise between about 85% to about 98.5% of silica sand, and about 5% to about 0.5% of a foundry resin. The resin used may be of any of numerous conventional core and mold foundry resin systems such as phenolic hot box, phenolic urethane, furan, sodium silicate including ester and carbon dioxide system, polyester binders, acrylic binders, alkaline binders, epoxy binders, and furan warm box systems. A particularly useful binder is a no-bake resin binder system available from Ashland. This resin binder system comprises a three part phenolic urethane system which includes a series of binders and a liquid catalyst. Each of the above binder systems is well known in the art and therefore a detailed description thereof is unnecessary.

The order of addition of bentonite is important to its function. The sand is preferably mixed with the bentonite first and then the foundry resin is added so that the resin coats the surface of the sand particles and provides a foundry sand composition with bentonite particles dispersed throughout. It is believed that in this manner the bentonite prevents the formation of fissures in the sand.

The anti-veining composition of the present invention comprises bentonite. In accordance with one aspect of the present invention, anti-veining additive will be added to the sand-based aggregate in an amount of from about 1% to 10% based on the mineral composition (the total amount of sand and anti-veining additive). More particularly, the anti-veining additive may be present in the aggregate in an amount from about 1% to 7% based on the mineral composition. The anti-veining additive may comprise bentonite alone or in combination with other materials. Bentonite is a type of clay composed primarily of montmorillonite minerals. The bentonite used in accordance with the present invention can be a sodium bentonite, a calcium bentonite, or mixture thereof. The composition may also contain other materials including clay minerals such as hectorite, illite, mixtures of illite and the family of smectites, shale, and other families of clay materials.

The anti-veining composition may also include other materials to supplement the anti-veining properties of the bentonite or otherwise improve the characteristics of the foundry composition. Examples of useful additives include materials capable of improving the tensile properties of the foundry core or mold. Specific mention may be made of coal slag and stearates which have been found to improve tensile properties of the composition. Coal slag can typically be employed at amounts up to about 50% of the anti-veining composition, more typically up to about 33%. Stearates, including but not limited to, calcium, magnesium, sodium and aluminum stearates, may be used at levels up to about 10% based on sand. One particular embodiment uses an anti-veining composition containing 7.6% aluminum stearate, 88% bentonite and 4.4% coal slag. The mineral composition comprises 95% sand and 5% of this particular anti-veining composition. The resin is subsequently added to this mineral composition. The addition of stearates and/or coal slag improves the product performance.

In accordance with a particular aspect of the present invention, the bentonite may be utilized in a granular form having an average particle size of from about 74μ to about 3.4 mm. More particularly, the granular bentonite clay may range in size from about 105μ to about 2.0 mm. The use of bentonite having a particle size smaller than 74μ has been found to give rise to no or only very little improvement in casting quality. In particular embodiments of the present invention, the particle size of the bentonite is from about 1.0 to 2.0 mm.

Particles having an average size of about 74μ or greater are those which are generally retained on the surface of a U.S. standard No. 200 mesh sieve screen. Particles having an average size of less than about 3.4 mm are those which generally pass through a U.S. standard No. 6 mesh sieve screen. Particles having an average particle size of 105μ or greater are those which are generally retained on a surface of a U.S. standard No. 140 mesh sieve screen. Particles having a nominal size of less than about 2.0 mm are those which generally pass through a U.S. standard No. 10 mesh sieve screen.

The moisture level of the bentonite clay can also affect the quality of the casting. If the moisture level is too high, the product can potentially fail, and, therefore, it is believed that veining decreases with decreasing moisture levels. However, from a practical standpoint, the bentonite will typically have a moisture level of from 0.1% to about 15%, more particularly from about 6% to 10% with a target moisture level of about 8%.

It is within the scope of the present invention to incorporate other anti-veining compounds in the silica sand-based foundry composition. Examples of specific anti-veining compounds include, but are not limited to, dextrin, starch-based products, fine ground glass particles, red talc, wood flour, and lithia-containing materials. In accordance with a particular embodiment of the present invention, the anti-veining composition comprises a mixture of lithia-containing material described in U.S. Pat. No. 5,911,269 and bentonite. The other anti-veining compounds and more particularly the lithia-containing material can be used with the bentonite in a ratio from about 3 to 1 to 1 to 3 lithia-containing material to bentonite.

The present invention is further illustrated by the following, non-limiting examples.

### EXAMPLES

Different silica sand-based foundry compositions were prepared for the purpose of evaluating various anti-veining additives for effectiveness in preventing veining and for tensile properties. Accordingly, identical silica sand-based aggregate mixes were prepared utilizing various anti-veining additives. Test samples were prepared by blending the silica sand and the anti-veining material in a mixer for 30 seconds. The addition of the 3 part Ashland binder system was completed according to the manufacturer's recommendations. The testing specimens were prepared for evaluation.

Tables 1 and 2 summarize the effectiveness of various anti-veining additives. Table 1 is directed to sand cores coated with EZ Kote Graphite Coating while Table 2 is directed to uncoated cores.

TABLE 1
Comparison Of Anti-Veining Additives
Coated Sand Cores

| | Formula (wt) (g) | | | | | |
|---|---|---|---|---|---|---|
| | | | Example 2 | | | |
| Material | Control | Example 1 | (Comparative) | Example 3 | Example 4 | Example 5 |
| Ashland (Part 1) | 10 | 10 | 10 | 10 | 10 | 10 |
| Pepset XI 1000 | | | | | | |
| Ashalnd (Part 2) | 8 | 8 | 8 | 8 | 8 | 8 |
| Pepset XII 2000 | | | | | | |
| Ashland Catalyst 3502 | 0.5 | 0.5 | 0.5 | 0.5 | 0.5 | 0.5 |
| Sand | 2000 | 1900 | 1900 | 1900 | 1940 | 1860 |
| Bentonite (#40) | — | 100 | — | 100 | 60 | 140 |
| Veinseal | — | — | 100 | — | — | — |
| | | | | — | | |

Veining (# observed)

| | | | | | | |
|---|---|---|---|---|---|---|
| Horizontal | 1 | None | None | None | 1 | None |
| Vertical | 2 | None | None | None | 2 | None |

Examples 1 and 2 illustrate the effectiveness of bentonite as an anti-veining additive as compared to a commercially available lithium-containing anti-veining additive. Examples 3-5 illustrate the effect of bentonite concentration on anti-veining.

TABLE 2
Comparison Of Anti-Veining Additives
Uncoated Sand Cores

Formula (wt) (g)

| Material | Control | Example 6 |
|---|---|---|
| Ashland (Part 1) Pepset XI 1000 | 10 | 10 |
| Ashland (Part 2) Pepset XII 2000 | 8 | 8 |
| Ashland Catalyst 3502 | 0.5 | 0.5 |
| Sand | 2000 | 1900 |
| Bentonite | — | 100 |

Veining (# observed)

| | | |
|---|---|---|
| Horizontal | 2 | None |
| Vertical | 4 | 1 (minor) |

The tensile properties of various compositions were calculated based on the retained tensile strength in reference to the control material as indicated in Table 3 below. Tensile strength is important to maintain the desired form of the mold or core before and during casting.

TABLE 3
Comparison Of Anti-Veining Additives
Uncoated Sand Cores
Retained Tensile Properties of Anti-Veining Aggregates

| | Formulation of Prepared Mixtures (wt) (g) | | | | | | | |
|---|---|---|---|---|---|---|---|---|
| | | Example | Example | Example | Example | Example | Example | Example |
| Material | Control | 7 | 8 | 9 | 10 | 11 | 12 | 13 |
| Ashland (Part 1) | 10 | 10 | 10 | 10 | 10 | 10 | 10 | 10 |
| Pepset XI 1000 | | | | | | | | |
| Ashland (Part 2) | 8 | 8 | 8 | 8 | 8 | 8 | 8 | 8 |
| Pepset XII 2000 | | | | | | | | |
| Catalyst | 0.5 | 0.5 | 0.5 | 0.5 | 0.5 | 0.5 | 0.5 | 0.5 |
| Sand | 2000 | 1970 | 1970 | 1970 | 1970 | 1970 | 1970 | 1900 |
| Dextrin | | 30 | 20 | 10 | — | — | — | — |
| Bentonite (#40) | — | — | 0 | 0 | 0 | 0 | 0 | 100 |
| Bentonite (#200) | | | 10 | 20 | 7.5 | 15 | 22.5 | 0 |
| Iron Oxide | — | — | — | — | 22.5 | 15 | 7.5 | — |
| Relative Tensile | 100% | 34% | 7% | 1% | 39% | 7% | 4% | 47% |
| Strength | | | | | | | | |

Veining (# Observed)

| | | | | | | | | |
|---|---|---|---|---|---|---|---|---|
| Horizontal | 3 | 2 | 2 | 2 | 1 | 1 | 1 | 1 Minor |
| Vertical | 4 | 2 | 2 | 0 | 3 | 2 | 1 | 0 |

Tables 4 and 5 illustrate additional examples in accordance with some embodiments of the present invention.

TABLE 4
Comparison Of Anti-Veining Additives
Uncoated Sand Cores

| | Formula (wt) (g) | | | | |
|---|---|---|---|---|---|
| | | | Example 15 | | Example |
| Material | Control | Example 14 | (Comparative) | Example 16 | 17 |
| Ashland (Part 1) | 10 | 10 | 10 | 10 | 10 |
| Pepset XI 1000 | | | | | |
| Ashland (Part 2) | 8 | 8 | 8 | 8 | 8 |
| Pepset XII 2000 | | | | | |
| Ashland Catalyst 3502 | 0.5 | 0.5 | 0.5 | 0.5 | 0.5 |
| Sand | 2000 | 1900 | 1900 | 1900 | 1900 |
| Bentonite (#40) | — | 100 | — | — | — |
| Veinseal | — | — | 100 | — | — |
| Calcium Bent. (Gran) | | | | 100 | |
| Shale | | | | | 100 |

Veining (# observed)

| | | | | | |
|---|---|---|---|---|---|
| Horizontal | 3 | None | None | None | 1 |
| Vertical | 4 | None | None | None | 2 minor |

TABLE 5
Comparison Of Anti-Veining Additives
Uncoated Sand Cores

| | Formula (wt) (g) | | | | | |
|---|---|---|---|---|---|---|
| | | | Example 15 | | | |
| Material | Control | Example 14 | (Comparative) | Example 18 | Example 19 | Example 20 |
| Ashland (Part 1) | 10 | 10 | 10 | 10 | 10 | 10 |
| Pepset XI 1000 | | | | | | |
| Ashland (Part 2) | 8 | 8 | 8 | 8 | 8 | 8 |
| Pepset XII 2000 | | | | | | |
| Ashland Catalyst | 0.5 | 0.5 | 0.5 | 0.5 | 0.5 | 0.5 |
| 3502 | | | | | | |
| Sand | 2000 | 1900 | 1900 | 1900 | 1900 | 1900 |
| Bentonite (#40) | — | 100 | — | 25 | 50 | 75 |
| Veinseal | — | — | 100 | 75 | 50 | 25 |

Veining (# observed)

| | | | | | | |
|---|---|---|---|---|---|---|
| Horizontal | 3 | None | None | None | 1 minor | 1 |
| Vertical | 4 | None | None | None | 1 minor | none |

Additional Test Casting Evaluations

In order to further illustrate the application of vein reduction compounds, an additional series of test castings was completed using a base 4 screen round grain silica sand and varying binders with uncoated (i.e., no graphite coating) cores. The various binders included:

1. Furan No-bake @ 1.2%

2. Furan Warm Box @ 1.2%

3. Phenolic Urethane Cold Box @ 1.2%

4. Phenolic Urethane No-bake @ 1.2%

5. Phenolic Hot Box @ 1.75%

6. Epoxy Acrylic Cold Box @ 1.2%

7. Alkaline Phenolic No-bake @ 1.75%

8. Alkaline Phenolic Cold Box @ 1.75%

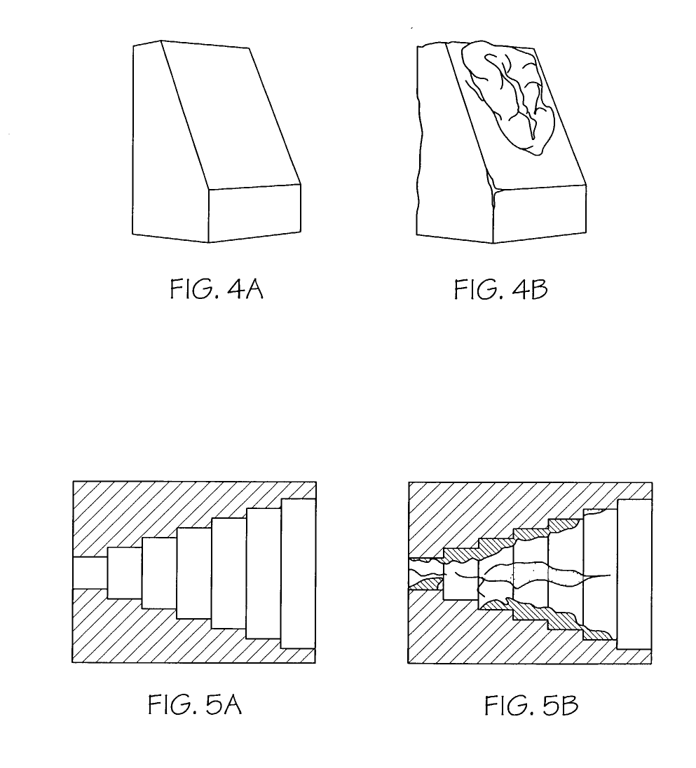

With the utilization of these binders (in conjunction with the conventional catalyst) in the percentages stated above in the round grain silica sand, a series of castings were produced to evaluate multiple characteristics of the vein reduction compounds. These castings included: Erosion Wedge Casting, Stepcone Castings, Penetration Casting, and Fluidity Spiral. The castings were compared on a rating scale of 1 (best) to 5 (worst). A visual illustration of the scale is found in FIGS. 4(a), 4(b), 5(a), 5(b), 6(a), 6(b), 7(a), 7(b), 8(a) and 8(b) of the drawings.

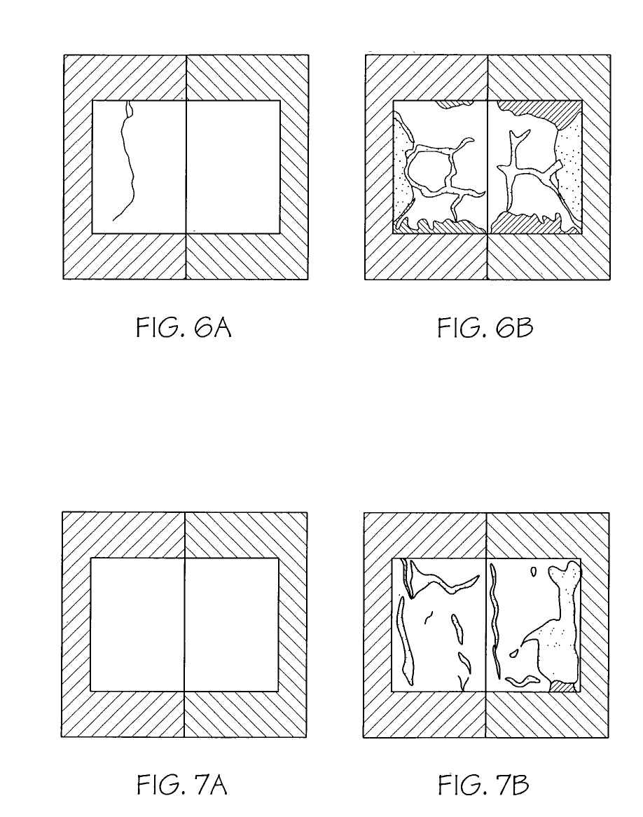

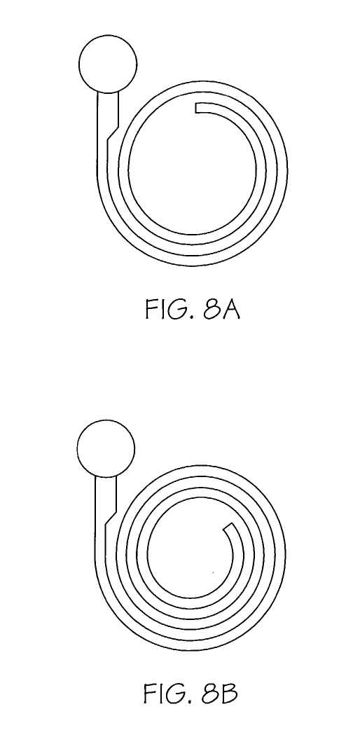

FIG. 4(a) is an illustration of the erosion wedge casting with the best rating 1. FIG. 4(b) is an illustration of the erosion wedge casting with the worst rating 5. FIG. 5(a) is an illustration of the stepcone casting vein with the best rating 1. FIG. 5(b) is an illustration of the stepcone casting vein with the poor rating 4. FIG. 6(a) is an illustration of the penetration casting vein with the best rating 1. FIG. 6(b) is an illustration of the penetration casting vein with the worst rating 5. FIG. 7(a) is an illustration of the penetration casting penetration with the best rating 1. FIG. 7(b) is an illustration of the penetration casting penetration with the worst rating 5. FIG. 8(a) is an illustration of the fluidity spiral—flow in inches (41 in). FIG. 8(b) is an illustration of the fluidity spiral—flow in inches (52 in).

The results of the evaluation are summarized in Tables 6 and 7. Blend 1 consisted of bentonite. Blend 2 was a 50/50 mixture of bentonite and coal slag. The vein reduction additive was added to the sand in an amount of 5% by weight of the mineral composition.

TABLE 6
Evaluation of Blend 1 in Various Binders

| | | | Stepcone | Stepcone | Penetration | Penetration | |
|---|---|---|---|---|---|---|---|
| Casting Defect | Erosion | Erosion | Veining | Veining | Casting | Casting | |
| Analysis/Resin | No | 5% Blend | No | 5% Blend | Veining | Veining | Penetration |
| Binder | Additive | 1 | Additive | 1 | No Additive | 5% Blend 1 | No Additive |
| Furan No-bake | 1 | 1 | 2 | 1.5 | 3 | 2.5 | 3 |
| Furan Warm | Not | Not | Not | Not | 3 | 1.5 | 1.5 |
| Box | Available | Available | Available | Available | | | |
| Phenolic | 1.5 | 1.5 | 4.5 | 3 | 5 | 4.5 | 2 |
| Urethane Cold | | | | | | | |
| Box | | | | | | | |
| Phenolic | 1.5 | 2 | 3.5 | 2.5 | 5 | 4 | 1.5 |
| Urethane No- | | | | | | | |
| Bake | | | | | | | |
| Phenolic Hot | Not | Not | Not | Not | 4.5 | 3 | 2.5 |
| Box | Available | Available | Available | Available | | | |
| Epoxy Acrylic | 5 | 5 | 3 | 1 | 4 | 1 | 2.5 |
| Cold Box | | | | | | | |
| Alkaline | 1 | 1 | 3 | 2.5 | 2 | 1 | 4 |
| Phenolic No- | | | | | | | |
| bake | | | | | | | |
| Alkaline | 1 | 1 | 3 | 1 | 3.5 | 1 | 5 |
| Phenolic Cold | | | | | | | |
| Box | | | | | | | |

| | | | | | Fluidity |
|---|---|---|---|---|---|
| | | | | | Spiral |
| | | | | Fluidity | (Flow in |
| Casting Defect | | Surface | Surface | Spiral (Flow | inches |
| Analysis/Resin | Penetration | Finish | Finish | in inches | 5% Blend |
| Binder | 5% Blend 1 | No Additive | 5% Blend 1 | No Additive | 1 |
| Furan No-bake | 1.5 | 1.5 | 2 | 41 | 47.5 |
| Furan Warm | 1 | 1 | 2 | Not | Not |
| Box | | | | Available | Available |
| Phenolic | 1.5 | 1.5 | 2 | Not | Not |
| Urethane Cold | | | | Available | Available |
| Box | | | | | |
| Phenolic | 1.5 | 1.5 | 2 | 44.5 | 46.5 |
| Urethane No- | | | | | |
| Bake | | | | | |
| Phenolic Hot | 1 | 1 | 2 | Not | Not |
| Box | | | | Available | Available |
| Epoxy Acrylic | 1 | 2 | 3 | 47 | 52 |
| Cold Box | | | | | |
| Alkaline | 1 | 1.5 | 2 | 45 | 45 |
| Phenolic No- | | | | | |
| bake | | | | | |
| Alkaline | 1 | 1.5 | 2.5 | Not | Not |
| Phenolic Cold | | | | Available | Available |
| Box | | | | | |

TABLE 7

| | | | Stepcone | Stepcone | Penetration | Penetration | |
|---|---|---|---|---|---|---|---|
| Casting Defect | Erosion | Erosion | Veining | Veining | Casting | Casting | |
| Analysis/Resin | No | 5% Blend | No | 5% Blend | Veining | Veining | Penetration |
| Binder | Additive | 2 | Additive | 2 | No Additive | 5% Blend 2 | No Additive |
| Furan No-bake | 1 | 1 | 2 | 2 | 3 | 2.5 | 3 |
| Furan Warm | Not | Not | Not | Not | 3 | 1.5 | 1.5 |
| Box | Available | Available | Available | Available | | | |
| Phenolic | 1.5 | 1.5 | 4.5 | 3 | 5 | 4.5 | 2 |
| Urethane Cold | | | | | | | |
| Box | | | | | | | |
| Phenolic | 1.5 | 1.5 | 3.5 | 2 | 5 | 4 | 1.5 |
| Urethane No- | | | | | | | |
| Bake | | | | | | | |
| Phenolic Hot | Not | Not | Not | Not | 4.5 | 3.5 | 2.5 |
| Box | Available | Available | Available | Available | | | |
| Epoxy Acrylic | 5 | 5 | 3 | 1.5 | 4 | 2 | 2.5 |
| Cold Box | | | | | | | |
| Alkaline | 1 | 1 | 3 | 3 | 2 | 2 | 4 |
| Phenolic No- | | | | | | | |
| bake | | | | | | | |
| Alkaline | 1 | 1 | 3 | 1.5 | 3.5 | 2 | 5 |
| Phenolic Cold | | | | | | | |
| Box | | | | | | | |

| | | | | | Fluidity |
|---|---|---|---|---|---|
| | | | | | Spiral |
| | | | | Fluidity | (Flow in |
| Casting Defect | | Surface | Surface | Spiral (Flow | inches |
| Analysis/Resin | Penetration | Finish | Finish | in inches | 5% Blend |
| Binder | 5% Blend 2 | No Additive | 5% Blend 2 | No Additive | 2 |
| Furan No-bake | 1.5 | 1.5 | 3.5 | Not | Not |
| | | | | Available | Available |
| Furan Warm | 1 | 1 | 4 | Not | Not |
| Box | | | | Available | Available |
| Phenolic | 1.5 | 1.5 | 3.5 | Not | Not |
| Urethane Cold | | | | Available | Available |
| Box | | | | | |
| Phenolic | 1.5 | 1.5 | 2 | 44.5 | 44 |
| Urethane No- | | | | | |
| Bake | | | | | |
| Phenolic Hot | 1 | 1 | 3 | Not | Not |
| Box | | | | Available | Available |
| Epoxy Acrylic | 1 | 2 | 4 | 47 | 50 |
| Cold Box | | | | | |
| Alkaline | 1 | 1.5 | 3.5 | 45 | 48.5 |
| Phenolic No- | | | | | |
| bake | | | | | |
| Alkaline | 1 | 1.5 | 4 | Not | Not |
| Phenolic Cold | | | | Available | Availbel |
| Box | | | | | |

In general, the vein reducing compounds have both positive and negative effects on the casting results. The erosion characteristics are basically unaffected, veining resistance is improved, surface finish has contradictory results (penetration improved but surface finish reduced) and there is an improvement in metal fluidity. The improvement in metal fluidity may be attributable to a gas absorption property inherent to the vein reducing additive.

The addition of materials into cores is known to result in varying degrees of deterioration of tensile properties. Historical data has shown that the addition of traditional materials such as a finely ground red iron oxide, dextrin, and other materials have a greater negative effect on tensile properties compared to newer generation (e.g., lithia based) additives that have been developed in the last 10 years. Variations in tensile strengths are dependent upon sand type, resin selection, resin concentration and the quantity of vein reduction compound. Because of these contributions to the tensile properties the comparison found in the following tables will use the rating scale 1 (best) to 5 (worst). Table 8 is based on a comparison of an initial casting series in which 2 inch specimens were prepared in the phenolic urethane no-bake resin in the 4 screen round grain silica sand at 1.0% binder level.

TABLE 8
Comparison of tensile strength of initial casting investigation

| Material | Tensile Strength |
|---|---|
| No Additive | 1 |
| 1.5% Addition Red Iron | 4 |
| Oxide | |
| 5% Competitive material | 2 |
| (lithium based) | |
| 5% Blend 1 | 3 |
| 5% Blend 2 | 2 |

A second study of tensile strength was completed using the binder systems discussed earlier (Tables 6 and 7). The results of this second study are shown in Table 9 based on a rating scale 1 (best) to 5 (worst).

TABLE 9
Comparison of tensile properties of prepared sand mixtures

| | | | | | 24 hour |
|---|---|---|---|---|---|
| Binder/Time | | Immediate | 1 hour | 24 hour | humidity |
| Furan No-bake | No Additive | 1 | 1 | 1 | 1 |
| Furan No-bake | 5% Blend 1 | 2 | 2 | 2 | 2 |
| Furan No-bake | 5% Blend 2 | 1 | 1 | 1 | 1 |
| Phenolic Urethane Cold Box | No Additive | 1 | 1 | 1 | 1 |
| Phenolic Urethane Cold Box | 5% Blend 1 | 3 | 3 | 3 | 3 |
| Phenolic Urethane Cold Box | 5% Blend 2 | 2 | 2 | 2 | 2 |
| Phenolic Urethane No-Bake | No Additive | 1 | 1 | 1 | 1 |
| Phenolic Urethane No-bake | 5% Blend 1 | 4 | 4 | 4 | 4 |
| Phenolic Urethane No-bake | 5% Blend 2 | 3 | 3 | 3 | 3 |
| Epoxy Acrylic Cold Box | No additive | 1 | 1 | 1 | 1 |
| Epoxy Acrylic Cold Box | 5% Blend 1 | 3 | 3 | 3 | 3 |
| Epoxy Acrylic Cold Box | 5% Blend 2 | 2 | 2 | 2 | 2 |
| Alkaline Phenolic No-bake | No Additive | 1 | 1 | 1 | 1 |
| Alkaline Phenolic No-bake | 5% Blend 1 | 2 | 2 | 2 | 2 |
| Alkaline Phenolic No-bake | 5% Blend 2 | 2 | 2 | 1 | 1 |
| Alkaline Phenolic Cold Box | No Additive | 1 | 1 | 1 | 1 |
| Alkaline Phenolic Cold Box | 5% Blend 1 | 3 | 3 | 3 | 3 |
| Alkaline Phenolic Cold Box | 5% Blend 2 | 2 | 2 | 2 | 2 |

In addition to this investigation, the comparison of the vein reduction in heat-cured binders can be found in Table 10.

TABLE 10
Comparison of tensile properties of prepared heat cured binders

| | | Hot Tensile | Hot Tensile | Cold | Cold |
|---|---|---|---|---|---|
| | | 20 sec. | 40 sec. | Tensile 20 sec | Tensile 40 sec. |
| | | Swell | Swell | Swell | Swell |
| Phenolic Hot Box | No Additive | 1 | 1 | 1 | 1 |
| Phenolic Hot Box | 5% Blend 1 | 3 | 3 | 3 | 3 |
| Phenolic Hot Box | 5% Blend 2 | 2 | 2 | 2 | 2 |
| Furan Warm Box | No Additive | 1 | 1 | 1 | 1 |
| Furan Warm Box | 5% Blend 1 | 4 | 4 | 4 | 4 |
| Furan Warm Box | 5% Blend 2 | 4 | 4 | 3 | 3 |

The results in Tables 9 and 10 show that the tensile improves if half of the bentonite is replaced with coal slag in the vein reducing blend. One useful coal slag is commercially available from Reed Minerals a division of Harsco Company and has a particle size of about 0.3 to 0.5 mm. The particle size of the coal slag may be selected to provide a uniform blend with the sand and the bentonite. If the particle size is too large, classification or non-uniform mixing will result. By blending the bentonite and the coal slag in different ratios, the vein reduction property can be balanced against the loss in tensile. Vein reducing compounds containing up to 50% coal slag and 50% bentonite have been used. Blends of 33% coal slag and 67% bentonite have also been effective.

In a further embodiment, the sand is modified to include up to 10% stearate. It is believed that tensile strength may be improved effectively by adding up to 10% of a stearate to the sand. Examples of stearates that may be used include, but are not limited to, calcium stearate, magnesium stearate, sodium stearate and aluminum stearate.

Since return core sand is returned to the green sand in the form of “core sand dilution”, it is important to review the impact that the vein reducing compounds have over and above the characteristics found in the return core sand itself. A limited amount of information was generated during the laboratory investigations. However, general information was gathered on the various core binders evaluated with the vein reduction compounds present. In general it was observed that when the vein reduction compounds were present, there was an increase in the pH and Acid Demand Value (ADV) of the “burnt” returned core sand. This impact can be viewed as both positive and negative.

From the perspective of green sand, a higher pH and acid demand value is a strong positive consideration. Bentonite bonded green sand prefers a basic pH. This characteristic will allow a green sand foundry to operate with a higher level of efficiency. Today's foundries are very concerned about the additives that are going into the green sand system for waste disposal purposes. The higher pH generated in these vein reduction compounds returned sand (9-10) is lower than the pH which has been determined for disposal (12 and higher). Therefore the sand is compatible with green sand but not a concern to the disposal issues. Since many foundries today return an extremely high level of return core sand because of the high level of core sand to metal ratio, this pH value has a positive impact. In addition, foundries have reduced the quantity of new sand addition and are depending on the return core sand as their principal source of sand addition to their green sand molding system. It is very important to note that it is always important to add new sand regardless of how much return core sand is present.

From the perspective of reclamation of the sand for reuse in mold and core making, the higher level of pH should be considered. The acid demand level in the return core sand is higher. Compensation for catalyst and or binder can be considered. However further investigations need to be completed to determine the full impact that the higher pH and acid demand value.

As indicated in the foregoing examples, the addition of bentonite to molding and core aggregates used in casting manufacture can significantly improve quality of the castings by reducing thermal expansion defects, such as veining. The addition of bentonite significantly reduces the casting defects associated with the use of foundry binder systems and molding sand aggregates and increases the strength the resulting bond aggregates. The use of bentonite as an anti-veining composition reduces the amount of surface grinding necessary to remove any imperfections at the surface of the casting. Furthermore, the cost of bentonite is less than other anti-veining additives thereby providing for lower cost mold and core production, while improving the resulting casting quality.

Having described the invention in detail by reference to particular embodiments thereof, it will be apparent that modifications and variations are possible without departing from the scope of the invention.

We claim:

1. A method for producing silica sand-based foundry shapes useful in forming metal castings, said method comprising the steps of:
providing a foundry sand, adding an anti-veining composition comprising bentonite to said foundry sand to form a mineral composition, and adding a foundry resin to said mineral composition to form a sand-based foundry composition; and
shaping said sand-based foundry composition to form a desired pattern, wherein said anti-veining composition reduces veining in metal castings prepared from said sand-based foundry composition.

2. The method of claim 1 wherein said bentonite is selected from the group consisting of sodium bentonite, calcium bentonite and combinations thereof.

3. The method of claim 2 wherein said anti-veining composition further comprises another clay mineral wherein said mineral is selected from the group consisting of hectorite, illite, smectites, shale, and mixtures thereof.

4. The method of claim 1 wherein said sand-based foundry composition contains from about 95% to about 99.5% by weight of said mineral composition and from about 5% to about 0.5% by weight of a polymerizable or curable foundry resin appropriate for sand cores and molds, and said mineral composition contains from about 1% to about 10% by weight of said anti-veining composition based on said mineral composition.

5. The method of claim 4 wherein said foundry resin is selected from the group consisting of phenolic hot box, phenolic urethane, furan, sodium silicate systems, polyester binders, acrylic binders, alkaline binders, epoxy binders and furan warm box systems.

6. The method of claim 1 wherein said bentonite is utilized in a granular form having an average particle size of from about 74μ to about 3.4 mm.

7. The method of claim 6 wherein said bentonite has a moisture level of from about 0.1% to 15%.

8. The method of claim 1 wherein said anti-veining composition contains up to about 10% stearate wherein said stearate increases tensile properties.

9. The method of claim 8 wherein said stearate is selected from the group consisting of calcium stearate, magnesium stearate, sodium stearate and aluminum stearate.

10. The method of claim 1 wherein said anti-veining composition contains up to about 50% coal slag wherein said coal slag increases tensile properties.

11. The method of claim 10 wherein said anti-veining composition further comprises a stearate.

12. A method of making a metal casting from sand-based foundry compositions comprising the steps of:
providing a foundry sand, adding an anti-veining composition comprising bentonite to said foundry sand to form a mineral composition, and adding a foundry resin to said mineral composition to form a sand-based foundry composition;
shaping said sand-based foundry composition to form a desired pattern, wherein said anti-veining composition reduces veining in metal castings prepared from said sand-based foundry composition; and
pouring molten metal into the pattern formed in said sand-based foundry composition to produce a metal casting having little or no veining.

13. The method of claim 12 wherein said foundry composition comprises a matrix of sand and foundry resin having bentonite particles uniformly dispersed therethrough, wherein said foundry composition matrix reduces thermal expansion defects.

14. The method of claim 12 wherein said bentonite is selected from the group consisting of sodium bentonite, calcium bentonite and combinations thereof.

15. The method of claim 14 wherein said anti-veining composition further comprises another clay mineral wherein said mineral is selected from the group consisting of hectorite, illite, smectites, shale, and mixtures thereof.

16. The method of claim 12 wherein said sand-based foundry composition contains about 95% to about 99.5% by weight of said mineral composition and from about 5% to about 0.5% by weight of a polymerizable or curable foundry resin appropriate for sand cores and molds, and said mineral composition contains from about 1% to about 10% by weight of said anti-veining composition based on said mineral composition.

17. The method of claim 16 wherein said foundry resin is selected from the group consisting of phenolic hot box, phenolic urethane, furan, sodium silicate systems, polyester binders, acrylic binders, alkaline binders, epoxy binders and furan warm box systems.

18. The method of claim 12 wherein said bentonite is utilized in a granular form having an average particle size of from about 74μ to about 3.4 mm.

19. The method of claim 18 wherein said bentonite has a moisture level of from about 3% to 15%.

20. The method of claim 12 wherein said anti-veining composition contains up to about 10% stearate wherein said stearate increases tensile properties.

21. The method of claim 20 wherein said stearate is selected from the group consisting of calcium stearate, magnesium stearate, sodium stearate, and aluminum stearate.

22. The method of claim 12 wherein said anti-veining composition contains up to about 50% coal slag, wherein said coal slag increases tensile properties.

23. The method of claim 22 wherein said anti-veining composition further comprises a stearate.
